(19) United States
(12) Patent Application Publication
(10) Pub. No.: US 2003/0068539 A1
(43) Pub. Date: Apr. 10, 2003

(54) Power-heat installation and method of producing electrical and thermal energy

(76) Inventors: Norbert Breuer, Ditzingen (DE); Christian Schiller, Leinf.-Echterdingen (DE); Oliver Marquardt, Stuttgart (DE)

Correspondence Address: STRIKER, STRIKER & STENBY, 103 East Neck Road, Huntington, NY, 11743, US

(21) Appl. No.: 10/264,249

(22) Filed: Oct. 2, 2002

(30) Foreign Application Priority Data
Oct. 4, 2001 (DE) 101 48 854.8

(51) Int. Cl. H01M 8/06; H01M 8/02; H01M 8/04

(52) U.S. Cl. 429/19; 429/34; 429/26; 429/17

(57) ABSTRACT

A power-heat installation for producing electrical and thermal energy has a converting unit for converting an initial material to a first hydrocarbon-enriched fluid, a fuel cell unit for converting a second hydrogen-enriched fluid produced by moisturizing the first fluid to a third hydrogen containing fluid, and at least one fluid storage unit for storing at least one of the fluids, and the installation is used for uncoupling of electrical and thermal energy generation.

### BACKGROUND OF THE INVENTION

The present invention relates to a power-heat installation and method of producing electrical and thermal energy.

In particular, in connection with further availability of electrical and thermal energy from regenerative or fossil fuels, the fuel cell technology becomes even more important. Frequently the hydrogen when necessary is produced example by a so-called reforming or partial oxidation of hydrocarbons is to be produced. Such hydrocarbon materials are available in form of conventional fuels such as natural gas, gasoline or diesel. However, other hydrocarbons, for example methan or methanol can be used as well.

The need of electrical energy in the majority of applications is time deendent. The requirements to the dynamics of fuel cell systems, in particular for supplying electrical energy are thereby relatively high. For example in stationary applications such as home energy applications, or in other words current generating home heating or the like, electrical and thermal loads in general are not proportionally connected with one another.

Fuel cell system which correspond to relatively high dynamics, due to not completely avoidable inertia of the preceding process stages for hydrocarbon preparation are however limited. For improving the dynamics the storage of electrical energy by means of corresponding accumulators or the like is known. However, in this approach it is disadvantageous that a comparitively low and energy density can be realized, as well as relatively high economical costs for energy storage.

### SUMMARY OF THE INVENTION

Accordingly, it is an object of the present invention to provide a power-heat installation for producing electrical and thermal energy with a fuel cell unit, which guarantees the generation of electrical energy substantially independent from the generation of thermal energy with an improved dynamic ratio of the installation.

In keeping with these objects and with others which will become apparent hereinafter, one feature of the present invention resides, briefly stated, in a power heat installation for producing electrical and thermal energy, comprising a converting unit for converting an initial material to a first hydrogen-enriched fluid; a fuel cell unit for converting a second hydrogen containing fluid produced by moisturizing the first fluid to a third hydrogen-containing fluid; and at least one fluid storage unit for storing at least one of the fluids.

The inventive power-heat installation is characterized in that at least one fluid storage unit is provided for storing at least one hydrogen-containing fluid.

By means of the inventive fluid storage, depending on the energy need of the consumer a corresponding fluid is stored and can be supplied again for generation of electrical or thermal energy to corresponding components. Thereby an advantageous time uncoupling of the electrical and thermal energy generation with a relatively high dynamics of the system, relatively high energy densities and in some cases relatively low economical cost can be realized.

Preferably the fluid storage is arranged in the flow direction before the fuel cell unit. Thereby it is possible that the first hydrogen containing fluid produced by the conversion unit can be stored intermediately. This leads in particular to a substantially improved dynamics, for example during electrical load demands, since the release of the intermediately stored hydrogen-containing fluid or mixture in flow direction before the fuel cell unit shortens the response time of the fuel cell unit and thereby the whole system significantly, in some cases to fractions of seconds.

Stationary power-heat installations which combine the generation of electrical energy with the generation of the thermal energy and have a fuel cell unit, can react both to requirements for thermal energy as well as of electrical energy in accordance with the present invention relatively flexibly. For example, within the frame of stationary use, for example with block heating power plants for apartments, houses, plants and the like, in the case of generally increased heat consumption early in the morning a hydrogen-containing fluid is produced by the conversion unit and is stored before the fuel cell unit. In some cases during the mid day time the need for electrical energy is frequently significantly higher than the heat need, so that in this time period the chemical energy preferably stored in the morning by means of the fluid storage unit in accordance with the present invention is used for electrical current generator. This advantageous process course allows to provide small dimensions of the fuel-gas generation or conversion unit, whereby considerable economical cost saving can be obtained.

Moreover, it is recommended that several fluid storage units are provided before the fuel cell unit as well as in a flow direction after the conversion unit and/or in some cases available fluid cleaning stages, such as for example shift stages, fine cleaning stages or the like. Corresponding shift-or fine cleaning stages are provided in particular for reducing carbon monoxide content in hydrogen-enriched fluid stream or reformate. As a result different qualities of the first hydrogen-containing fluid in some cases can be supplied by the corresponding fluid storage units. Depending on the subsequent application purpose, the different qualities of the first hydrogencontaining fluid can be utilized. In particular the fluid which is cleaned from carbon monoxide and have higher quality can be supplied when needed to the fuel cell unit for producing electrical energy. Fluids with low quality can be supplied for example for combustion or heating of the reformers or the like in a cold starting phase of these components.

In accordance with an advantageous embodiment of the invention, the fluid storage unit is arranged at least in the flow direction behind the fuel cell unit. The correspondingly arranged fuel storage unit allows the storage of the third hydrogen-containing fluid, whereby this can be used in advantageous manner first of all for time uncoupled conversion of heat energy. In some cases by means of the intermediately stored third hydrogen-containing fluid during a cold start phase of the installation or the like, individual or several components of the power-heat installation can be heated by corresponding heat-exchanging heating devices at least partially to an operational temperature.

Preferably a particularly catalytically active heating device can be provided for combustion of at least one fluid. For example, the previously performed combustion of the third hydrogen-containing fluid can be here realized. Moreover, also the other fluids and/or initial materials can be burned by means of the heating device, so that with the use of the inventive fluid storage unit a significant uncoupling of the generation of thermal energy from the generation of electrical energy can be realized. For example, in a particular variant of the invention, when needed in a corresponding operational phase exclusively thermal energy can be produced without simultaneous production of electrical energy. This allows a significant load uncoupling between electrical and thermal energy.

In advantageous embodiment of the invention, the heating device is in thermal contact with the converting unit. By means of this arrangement by combustion of one of the fluids, in particular the third hydrogen-containing fluid, heat can be generated. It can be provided preferably for heating of the conversion unit which operates in some cases endothermically and/or for heating one or several components of the installation in a cold starting phase.

Advantageously, at least one heat exchange unit is provided for heating a heating fluid, so that the produced thermal energy of the power heat installation for corresponding consumers or loads is advantageously uncoupled from the installation.

In a particular variant of the invention, the heat exchange unit is in thermal contact with the fuel cell unit. Thereby it is possible that the fuel cell unit which operates generally exothermically makes available heat for heating the heating fluid. This makes possible an advantageous energy integration and thereby an increase of the efficiency of the total installation, a particularly compact design or a economical efficient favorable generation of electrical and thermal energy.

In advantageous embodiment of the invention, the heat exchange unit is in thermally conductive connection with the heating device. Alternatively, or in combination with the previously described variants, by means of this heat exchange unit a further possibility for uncoupling of thermal energy with simultaneous relatively high integration of the generated heat energy can be realized.

Generally, the power-heat installation in accordance with the present invention operates substantially constantly, so that in an advantageous manner the number of stationary operation points and thereby in particular the fuel availability or in other words preceding process by means of the conversion unit can be substantially similar to those in the prior art. Due to the reduced number as well as the lowered temperature differences of the temperature exchange, a relatively high service life of the power heat installation in accordance with the present invention can be realized by the lowered temperature exchange loads, in particular in preceding process.

Preferably with low temperature exchange loads of the installation the range of the used material for the corresponding components of the power-heat installation is increased. Correspondingly for example in addition to metallic materials also ceramic materials can be used for the devices or apparatuses of the preliminary process in particular the conversion unit including its cleaning stages.

Basically the fluids provided in the fluid storage units and first of all hydrogen containing gasses or gas-steam mixture are produced preferably before the conversion unit or with hydrogen availability from hydrocarbon materials, such as for example natural gas, ethanol or the like.

The fluid storage units in accordance with the present invention can be formed both as pressure gas accumulators or filled with different materials. Corresponding materials are formed so that the receiving capability of the fluid storage unit for the fluid or the fluid mixture is increased. Moreover, these materials can be regularly or irregularly structured solid materials . For example it is recommended that the process gas hydrogen is provided in a metal hybrid. With this method, in some cases a compact storage of hydrogen, and first of all before the anode side of a fuel cell, for example a PEM combustion cell or the like can be realized.

Also, the intermediate storage of components of a fluid gas mixture can be recommended by absorption or by chemi sorption processes in a suitable fluid. By desorption processes for example selectively absorbing gasses can be first of all released in another partial process steps, so that in advantageous manner the uncoupling between electrical and thermal energy in accordance with the present invention can be realized.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic block diagram of a power-heat device in accordance with the present invention.

### DESCRIPTION OF THE PREFERRED EMBODIMENTS

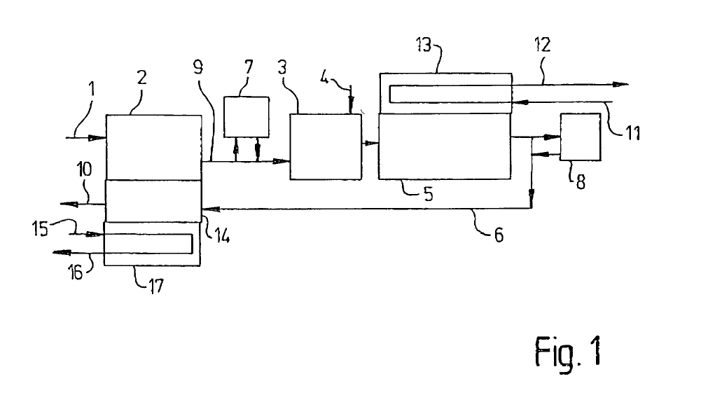

As shown in FIG. 1 an educt stream 1 is supplied to a preceding process for hydrogen preparation, in particular a reformer 2 which in some cases in dependence on a fuel cell 5, for example PEM fuel cell or SOFS, includes one or several not shown cleaning stages, and first of all for CO removal.

An optionally provided intermediate storage 7 stores a reformat 9 produced by the reformer 2 in certain operational phases, in which relatively low electrical energy must be produced by the fuel cell 5. In a not shown manner for this purpose at least one regulatable dosing element, dosing valve or the like and/or a pressure generating unit, such as for example a condenser or the like can be provided for pressure loading of the supplied fluid 9.

The reformate of the reformer 2 is moisturized with a moisturizer 3, wherein a water supply 4 is provided. An anode spent gas stream 6 of the fuel cell 3 is optionally stored intermediately by an intermediate storage 8. For this purpose in some cases in a not shown manner corresponding dosing elements or a condenser or the like can be provided. The anode spent gas of the fuel cell 5 is stored optionally by an intermediate storage 8. For this purpose not shown dosing elements or a condenser or the like can be provided. The anode spent gas stream 6 contains, when compared with the reformat 9 lower hydrogen quantities, which for example is burned by means of catalytically active combustion 14, whereby heat is released. This heat can be provided both for heating the reformer 2 as well as a heat exchanger 17 for heating a heating fluid stream 15. The heating of the reformer 2 is preferably performed during a cold start phase or an endothermally operating reforming or the like.

Moreover, an optionally provided heat exchanger 13 can be used for heating a heating fluid stream 11 to be heated. In some cases in a not shown manner the heat exchanger 17 and the heat exchanger 13 can be formed as a single heat exchanger, so that the structural expense for the power-heat installation in accordance with the present invention is additionally reduced.

Alternatively the heat exchangers 13, 17 can be formed as a two-stage heat exchanger, wherein the heating fluid stream 11 is heated, in comparison to the heat fluid stream 16, to different temperature levels, or in other words a heating fluid stream 12 has a temperature which is different from a heating fluid stream 16.

The heated heating fluid streams 12 or 16 can be used for utilization of their heat in some cases by a not shown heat exchanger for heating corresponding consumers or loads. For example buildings, reactors or the like can be heated or warmed up. The electrical energy produced by the fuel cell 5 can be supplied in a not shown manner to corresponding consumers or accumulators when needed.

In accordance with the invention, by means of the intermediate storage 7 and/or 8, a load uncoupling between electrical and thermal energy can be realized. Thereby the reaction time of the total system can be reduced, for example to fractions of seconds.

Moreover, with an advantageous process circuit a heat production without a current production can be performed. For this purpose the thermal uncoupling of the intermediately stored anode spent gas 6 and/or the reformate 9 is possible by means of the intermediate storage 7 in a heating circuit of the installation.

In the intermediate storage 7, for example depending on current consumption of a corresponding consumer, time dependent excessive hydrogen-containing gas or reformate 9 can be stored or withdrawn. By this intermediate storage before the fuel cell 5 a flexible reaction to electric load requirements is possible.

Alternatively or in combination with it, an introduction or withdrawal of the anode spent stream 6 can be realized by the intermediate storage 8. A preferable process course can be formed so that the stored hydrogen-as well as in some cases hydrocarbon-containing gas or gas steam mixture in case of high heat consumption, for example during cold starts of the reformer 2 or the like, can be burnt with the combustion 14. The exothermic combustion reaction is therefore coupled with endothermic process steps, and therefore in particular the combustion device 14 includes a heat exchanger or a heat exchanger 17 is provided. Generally the powerheat installation of the invention can have optionally a not shown additional burner, wherein with it the educt hydrocarbon containing educt is burned. The thereby produced heat in a not shown manner or in some cases by the heat exchangers 13, 17 can be coupled in the heat circuit or circuits of the power-heat installation in accordance with the present invention.

It will be understood that each of the elements described above, or two or more together, may also find a useful application in other types of constructions differing from the types described above.

While the invention has been illustrated and described as embodied in power heat installation and method of producing electrical and thermal energy, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A power-heat installation for generating electrical and thermal energy, comprising a converting unit for converting an initial material to a first hydrogen-enriched fluid; a fuel cell unit for converting a second hydrogen-enriched fluid produced by moisturizing the first fluid to a third hydrogen-containing fluid; and at least one fluid storage unit for storing at least one of the fluids.

2. A power heat installation as defined in claim 1, wherein said fluid storage unit is arranged in a flow direction at least before said fuel cell unit.

3. A power heat installation as defined in claim 1, wherein said fluid storage unit is arranged in a flow direction at least behind said fuel cell unit.

4. A power heat installation as defined in claim 1; and further comprising a heating device for burning at least one of the fluids.

5. A power heat installation as defined in claim 4, wherein said heating device is formed as a catalytically active heating device.

6. A power heat installation as defined in claim 4, wherein said heating device is in a thermal contact with said converting units.

7. A power heat installation as defined in claim 1; and further comprising at least one heat exchange unit for heating a heating fluid.

8. A power heat installation as defined in claim 7, wherein said heat exchange unit is in a thermal contact with said fuel cell unit.

9. A power heat installation as defined in claim 7, wherein said heat exchange unit is in a thermal contact with a heating device.

10. A method of producing electrical and thermal energy comprising the steps of converting an initial material by a conversion unit to a first hydrogen-enriched fluid; converting a second hydrogen-enriched fluid produced by moisturizing of the first fluid in a fuel cell unit, to a third hydrogen containing fluid; and storing at least one of the fluids by a fluid storage unit.

11. A method as defined in claim 10; and further comprising using a power-heat installation in which said conversions are performed and said storage is performed for a time uncoupling of an electrical and a thermal energy generation.
